(19) United States
(12) Patent Application Publication
(10) Pub. No.: US 2003/0194170 A1
(43) Pub. Date: Oct. 16, 2003

(54) Piezoelectric optical demultiplexing switch

(76) Inventors: Marvin Glenn Wong, Woodland Park, CO (US); Arthur Fong, Colorado Springs, CO (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/119,503

(22) Filed: Apr. 10, 2002

(51) Int. Cl. G02B 6/35

(52) U.S. Cl. 385/16

(57) ABSTRACT

The present invention uses a plurality of piezoelectric optical relays to demultiplex an optical signal. Each of the plurality of piezoelectric optical relays uses the deflection of a piezoelectric element to move an optical element into contact with the face of an optical path to redirect an optical signal. In its undeflected state, the optical signal is reflected from the angled face of the optical path by internal reflection. When the piezoelectric actuator moves the optical element into contact with the angled face of the optical path, the index of refraction of the optical path is matched and the optical signal enters the optical element and passes through.

### BACKGROUND

Piezoelectric materials and magnetostrictive materials (collectively referred to below as “piezoelectric materials”) deform when an electric field or magnetic field is applied. Thus piezoelectric materials, when used as an actuator, are capable or controlling the relative position of two surfaces.

Piezoelectricity is the general term to describe the property exhibited by certain crystals of becoming electrically polarized when stress is applied to them. Quartz is a good example of a piezoelectric crystal. If stress is applied to such a crystal, it will develop an electric moment proportional to the applied stress.

This is the direct piezoelectric effect. Conversely, if it is placed on an electric field, a piezoelectric crystal changes its shape slightly. This is the inverse piezoelectric effect.

One of the most used piezoelectric materials is the aforementioned quartz. Piezoelectricity is also exhibited by ferroelectric crystals, e.g. tourmaline and Rochelle salt. These already have a spontaneous polarization, and the piezoelectric effect shows up in them as a change in this polarization. Other piezoelectric materials include certain ceramic materials and certain polymer materials. Since they are capable of controlling the relative position of two surfaces, piezoelectric materials have been used in the past as valve actuators and positional controls for microscopes. Piezoelectric materials, especially those of the ceramic type, are capable of generating a large amount of force. However, they are only capable of generating a small displacement when a large voltage is applied. In the case of piezoelectric ceramics, this displacement can be a maximum of 0.1% of the length of the material. Thus, piezoelectric materials have been used as valve actuators and positional controls for applications requiring small displacements.

Two methods of generating more displacement per unit of applied voltage include bimorph assemblies and stack assemblies. Bimorph assemblies have two piezoelectric ceramic materials bonded together and constrained by a rim at their edges, such that when a voltage is applied, one of the piezoelectric materials expands. The resulting stress causes the materials to form a dome. The displacement at the center of the dome is larger than the shrinkage or expansion of the individual materials. However, constraining the rim of the bimorph assembly decreases the amount of available displacement. Moreover, the force generated by a bimorph assembly is significantly lower than the force that is generated by the shrinkage or expansion of the individual materials.

Stack assemblies contain multiple layers of piezoelectric materials interlaced with electrodes that are connected together. A voltage across the electrodes causes the stack to expand or contract. The displacement of the stack is equal to the sum of the displacements of the individual materials. Thus, to achieve reasonable displacement distances, a very high voltage or many layers are required. However, convention stack actuators lose positional control due to the thermal expansion of the piezoelectric material and the material(s) on which the stack is mounted.

Due to the high strength, or stiffness, of piezoelectric material, it is capable of opening and closing against high forces, such as the force generated by a high pressure acting on a large surface area. Thus, the high strength of the piezoelectric material allows for the use of a large valve opening, which reduces the displacement or actuation necessary to open or close the valve.

With a conventional piezoelectrically actuated relay, the relay is “closed” by moving a mechanical part so that two electrode components are in contact. The relay is “opened” by moving the mechanical part so the two electrode components are no longer in contact. The electrical switching point corresponds to the contact between the electrode components of the solid electrodes. Conventional piezoelectrically actuated relays, however, do not latch easily. If latching is available, a residual charge in the piezoelectric material is used or switch contacts that contain a latching mechanism is used.

Conventional optical relays and relay arrays use the creation of bubbles in the optical path to switch the optical signals and do not latch. Further, bubble type relays tend to have large power consumption and to generate unwanted heat.

### SUMMARY

The present invention uses the deflection of a piezoelectric element to move an optical element into contact with the face of an optical path to redirect an optical signal. In its undeflected state, the optical signal is reflected from the angled face of the optical path by internal reflection. When the piezoelectric actuator moves the optical element into contact with the angled face of the optical path, the index of refraction of the optical path is matched and the optical signal enters the optical element and passes through. Coatings that match the index of refraction of the optical path can be used on the optical element for higher efficiency. The optical switch actuator can use a bending mode piezoelectric element to displace the optical element. The optical switch actuator can also use other modes of piezoelectric elements to displace the optical element.

The current invention utilizes a plurality of the piezoelectric optical relays to demultiplex an optical signal. Each relay is connected one output of another relay. The states of the plurality of optical elements within the relays will determine the output of the demultiplexer.

### DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 shows a side view of a piezoelectric optical relay in accordance with the invention.

FIG. 2 shows a top view of an optical layer of a piezoelectric optical relay with the optical element undeflected in accordance with the invention.

FIG. 3 shows a top view of an optical layer of a piezoelectric optical relay with the optical element deflected in accordance with the invention.

FIG. 4 shows a plurality of piezoelectric optical relays in a demultiplexing switch in accordance with the invention.

### DETAILED DESCRIPTION OF THE INVENTION

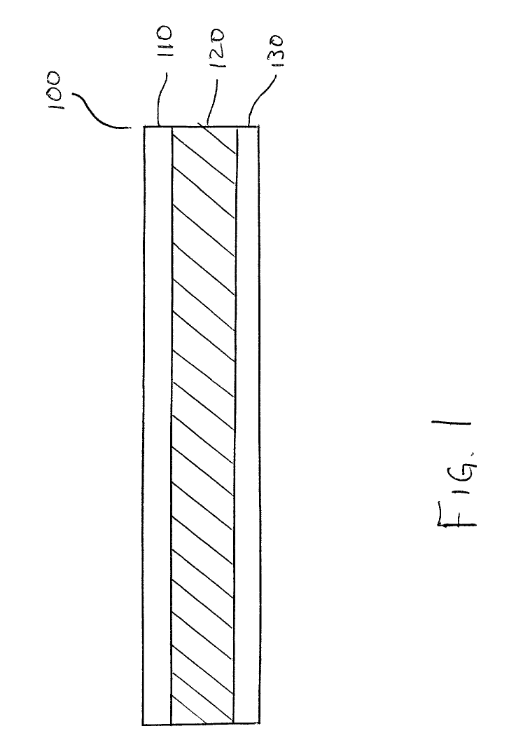

FIG. 1 is a side view of a piezoelectric optical relay 100 in accordance with the invention. Three layers of the relay 100 are shown. The top layer 110 is a cap layer that acts to seal the top of the relay. The middle layer 120 is an optical layer which houses the actuation means and optics of the relay. The bottom layer 130 is a cap layer which acts to seal the bottom of the relay. Any of the three layers 110, 120, 130 can be used to hold the electrical connections used to supply power to the actuation means of the relay. Preferrably, the middle optical layer 120 contains the electrical connections used to supply power to the actuation means of the relay.

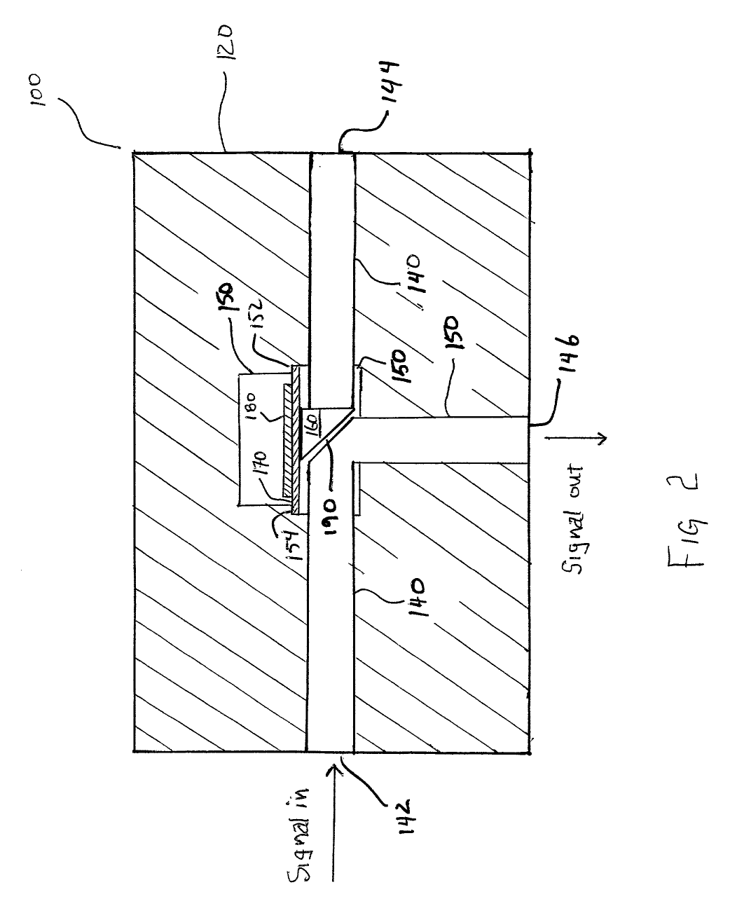

Referring now to FIG. 2, a top view of the optical layer 120 of the piezoelectric optical relay 100 in accordance with the invention is shown. An optical wave guide 140 passes through the layer 120. The wave guide 140 enters at a first point 142 where an optical signal enters the relay 100. The wave guide 140 diverges in the center of the optical layer 120. Two signal out paths 144, 146 stem from the divergence of the optical wave guide 140.

The wave guide 140 diverges in the center of the optical layer 120 inside of a chamber 150. The chamber 150 houses the actuation means for the relay 100. Inside the chamber 150 is a moveable optical path wedge 160, a diaphragm 170 which sits below the wedge 160 and is attached thereto, and a piezoelectric element 180. The wedge 160 is moveable in and out of a notch 190 in the wave guide 140.

The chamber 150 comprises at least two ledges 152, 154 which act as supports to which the diaphragm 170 is attachable. The diaphragm 170 attaches to the underside of the ledges 152,154. It is understood that the side walls of the chamber can be straight, without ledges. In such case, the diaphragm 170 attaches to the side walls. It will be obvious to those skilled in the art that many methods of attaching the diaphragm to the sidewalls is possible. For example only, the diaphram can be laminated to the sidewalls or the sidewalls can have notches sized to the diaphragm. Also as an example, the ledge could be upside-down of that shown in FIG. 1 so that the diaphragm sits on the ledge.

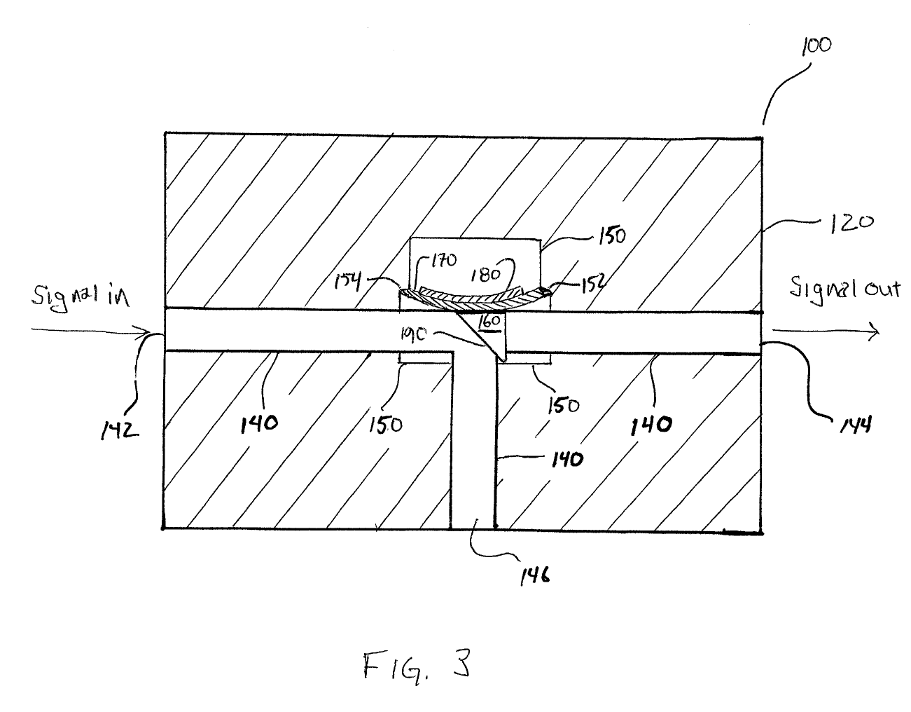

The piezoelectric element 180 is operable utilizing any mode of piezoelectric actuation. Preferrably, the piezoelectric element 180 is a bending mode piezoelectric element. The piezoelectric element 180 is attached to the diaphragm 170. Preferably the piezoelectric element 180 is laminated to the diaphragm 170 but it is understood that any method of maintaining enough proximity between the diaphragm and the piezoelectric element so that they will bend together and move the optical element is sufficient. The diaphragm 170 can be made of any material that is flexible. Preferably the diaphragm is made of stainless steel; alternative materials include brass, beryllium copper, spring steel, or piezoelectric material polarized and wired opposite to the piezoelectric element 180 so that when one expands the other shrinks to produce the bending action. Polymer may also be used. The circuit traces for the piezoelectric element 180 are not shown in FIG. 3.

In operation, the switching mechanism of the invention operates by displacement of the piezoelectric elements 180. In a preferred embodiment, the bending mode piezoelectric element 180 bends downward. Bending of the piezoelectric element 180 causes the diaphragm 170 to deflect downward. Downward deflection of the diaphragm 170 causes the optical element 160 to insert into the notch 190. The circuit traces for the piezoelectric element180 are not shown in FIG. 3.

FIG. 3 shows a top view of an optical layer 120 of a piezoelectric optical relay 100 with the optical element 160 deflected in accordance with the invention. Optical element 160 is deflected into the notch 190 so that an optical signal traveling entering at the first point 142 of the wave guide 140 will not reflect off of the angled face of the notch and be deflected along the waveguide toward port 146. When the piezoelectric element 180 bends the diaphragm 170 and moves the optical element 160 into contact with the face of the optical path 140, the index of refraction of the optical path 140 is matched and the optical signal enters the optical element 160. The optical signal travels through the optical element 160 and through signal out path 144. In a preferred embodiment of the invention, the optical element 160 is coated with a coating that matches the index of refraction of the optical path. The coating may be a material that is similar to the optical path and is typically composed of thin layers of transparent metal oxides. In a more preferred embodiment of the invention, the coating acts as a filter so that only the wavelength of choice is passed and all others are reflected. The filter works when the triangular element is down and in contact with the waveguide. When the triangular element is up, all of the wavelengths are deflected toward waveguide 146 by internal reflection.

Also in a preferred embodiment of the invention, the optical element 160 is triangular. It is understood that other shapes of optical elements can be used which provide for reflection into optical path 146 when not engaged and for refraction into optical path 144 when engaged. It is understood by those skilled in the art that the invention is not limited to the bending piezoelectric element 180 shown in the figures. For example, the piezoelectric element can be an extension mode piezoelectric element, a shear mode piezoelectric element or other mode of piezoelectric element capable of bending the diaphragm.

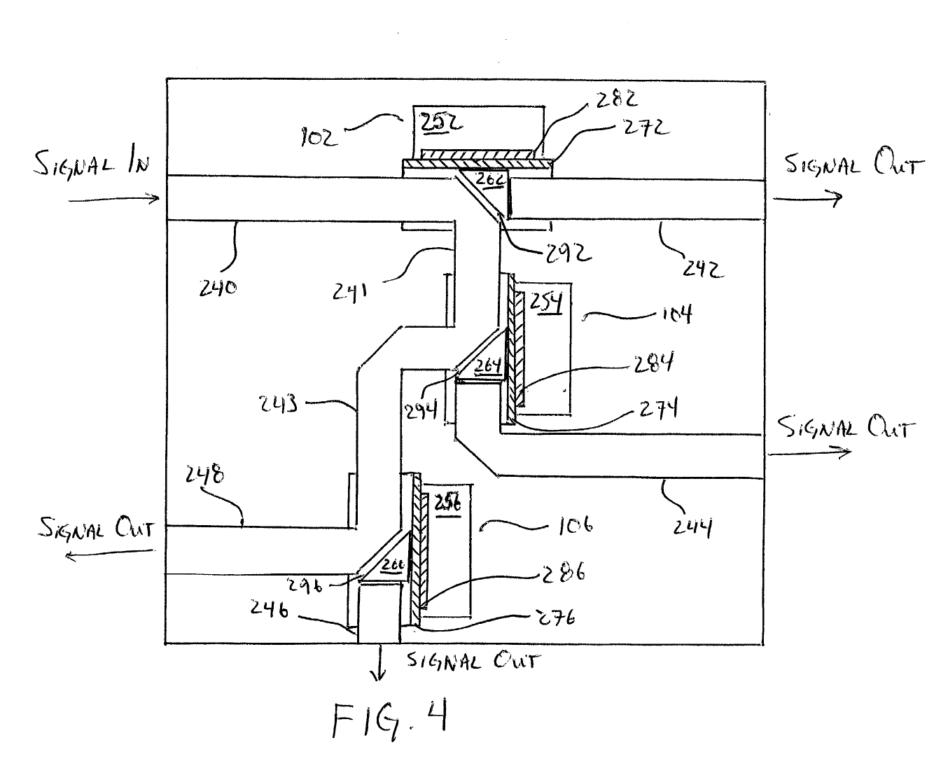

FIG. 4 shows a piezoelectric optical demultiplexing switch in accordance with the invention. For the purpose of explanation, three piezoelectric optical relays 102,104,106 are shown in FIG. 4. It is understood by those skilled in the art that more or less than three piezoelectric optical relays are possible. Each optical relay 102,104,106 comprises a plurality of piezoelectric elements 282,284,286, a plurality of diaphragms 272,274,276, a plurality of optical elements 262,264,266, and a plurality of chambers 252,254,256. The electrical connections to the piezoelectric elements 282,284,286 are not shown.

In operation, the piezoelectric optical relays 102,104,106 operate to demultiplex an optical signal entering the optical waveguide 240. The signal passes into the first relay 102. When the optical element 262 is not displaced into the notch 292 the signal reflects into the optical wave guide 241 and passes to the second relay 104. When the optical element 262 is displaced into the notch—due to deflection of the diaphragm 272 in turn due to deflection of the piezoelectric element 282—the signal refracts into the wave guide 242. It is understood that the wave guide 242 can lead to a signal out port, as shown in the figure, or can lead to other relays.

An optical signal reflected off of an undeflected optical element 262 into wave guide 241 will travel to the second relay 104 where it will either be reflected into wave guide 243 or refracted into wave guide 244. As in the first relay 102, whether the signal is reflected or refracted depends on the state of the optical element 264. An optical signal that is reflected into wave guide 243 will pass to a third relay 106 where the same process will occur. It is understood that a signal passing through any wave guide can pass to an additional relay. As such, the demultiplexing scheme of the invention is not limited to a set number of relays.

While only specific embodiments of the present invention have been described above, it will occur to a person skilled in the art that various modifications can be made within the scope of the appended claims.

What is claimed is:

1. A piezoelectric optical demultiplexing switch comprising:
a first optical relay and a plurality of secondary piezoelectric optical relays, each of said relays comprising a piezoelectric element; a diaphragm having a first and a second side, said first side abutting said piezoelectric element; an optical path comprising an entry point, a first egression point, a second egression point and a divergence point, said divergence point comprising a notch in said path; an optical element affixed to said second side, said optical element being moveable into said notch; a signal in port; and a first and second signal out port;
wherein the signal in port of said first optical relays connects to an optical signal source exterior to said demultiplexer and the signal in port of said plurality of optical relays connects to a signal out port of one of said plurality of relays.

2. The piezoelectric optical demultiplexing switch of claim 1, wherein said signal in ports and said signal out ports comprise optical wave guides.

3. The piezoelectric optical demultiplexing switch of claim 2 wherein each of said first relay and said plurality of secondary relays further comprise a chamber wherein said piezoelectric element, said diaphragm, said optical element and said divergence point are within said chamber.

4. The piezoelectric optical demultiplexing switch of claim 3 wherein said piezoelectric elements are a bending mode piezoelectric element.

5. The piezoelectric optical demultiplexing switch of claim 4 wherein said piezoelectric elements are laminated to said diaphragms.

6. The piezoelectric optical demultiplexing switch of claim 5 wherein said optical elements are triangular.

7. The piezoelectrical optical demultiplexing switch of claim 6 wherein said optical elements are coated with a substance so that the index of refraction substantially matches the optical path.

8. A piezoelectric optical demultiplexing switch comprising:
at least a first, second and third optical, each of said relays comprising a piezoelectric element; a diaphragm having a first and a second side, said first side abutting said piezoelectric element; an optical path comprising an entry point, a first egression point, a second egression point and a divergence point, said divergence point comprising a notch in said path; an optical element affixed to said second side, said optical element being moveable into said notch; a signal in port; and a first and second signal out port;
wherein the signal in port of said first optical relays connects to an optical signal source exterior to said demultiplexer, the signal in port of said second relay connects to a signal out port of said first relay and the signal in port of said third relay connects to a signal out port of said second relay.

9. The piezoelectric optical demultiplexing switch of claim 8, wherein said signal in ports and said signal out ports comprise optical wave guides.

10. The piezoelectric optical demultiplexing switch of claim 9 wherein each of said relays further comprise a chamber wherein said piezoelectric element, said diaphragm, said optical element and said divergence point are with said chamber.

11. The piezoelectric optical demultiplexing switch of claim 10 wherein said piezoelectric elements are a bending mode piezoelectric element.

12. The piezoelectric optical demultiplexing switch of claim 11 wherein said piezoelectric elements are laminated to said diaphragms.

13. The piezoelectric optical demultiplexing switch of claim 12 wherein said optical elements are triangular.

14. The piezoelectrical optical demultiplexing switch of claim 13 wherein said optical elements are coated with a substance so that the index of refraction substantially matches the optical path.
